(19) United States
(12) Patent Application Publication
(10) Pub. No.: US 2015/0179070 A1
(43) Pub. Date: Jun. 25, 2015

(54) Location-Based Vehicle Parking System

(71) Applicant: Frogparking Limited, Palmerston North (NZ)

(72) Inventor: Donald H. Sandbrook, Palmerston North (NZ)

(73) Assignee: Frogparking Limited, Palmerston North (NZ)

(21) Appl. No.: 14/136,415

(22) Filed: Dec. 20, 2013

(51) Int. Cl. G08G 1/14

(52) U.S. Cl. CPC G08G 1/149

(57) ABSTRACT

A location-based vehicle parking system for efficiently managing vehicle parking permissions for a parking space. The location-based vehicle parking system generally includes determining the presence of a vehicle within a parking space by a parking sensor, communicating sensor data to a management server, communicating vehicle data to the management server by a permit device within the vehicle, and determining if the vehicle is authorized to park within the parking space. A communication is sent to an inspector to manually verify permissions for a vehicle in a parking space if not authorized.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a vehicle parking system and more specifically it relates to a location-based vehicle parking system for efficiently managing vehicle parking permissions for a parking space.

2. Description of the Related Art

Any discussion of the related art throughout the specification should in no way be considered as an admission that such related art is widely known or forms part of common general knowledge in the field.

Vehicle parking space management systems have been in use for years for managing parking spaces for vehicles. One example of a parking management system is conventional parking meters that a user pays a specified amount of money into for a specified period of time. Another example of a parking management system is a parking lot attendant that receives payment based upon the amount of time a vehicle was parked in the parking lot. Another example of a parking management system is where a person purchases a parking permit and visibly displays the parking permit in the window of the vehicle to indicate that the vehicle is authorized to park in the parking space.

One problem with the previously discussed parking management systems is that they are labor intensive and therefore costly to maintain. Another problem with the previously discussed parking management systems is that manual verification is required to determine whether a vehicle is authorized for a particular parking space resulting in increased expense and lost revenue from lack of enforcement.

Because of the inherent problems with the related art, there is a need for a new and improved location-based vehicle parking system for efficiently managing vehicle parking permissions for a parking space.

### BRIEF SUMMARY OF THE INVENTION

The invention generally relates to a location-based vehicle parking system which includes determining the presence of a vehicle within a parking space by a parking sensor, communicating sensor data to a management server, communicating vehicle data to the management server by a permit device within the vehicle, and determining if the vehicle is authorized to park within the parking space. A communication is sent to an inspector to manually verify permissions for a vehicle in a parking space if not authorized.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an illustration of the overall communications of the present invention utilizing parking sensors.

FIG. 2 is an illustration of a parking lot with a plurality of parking spaces and parking sensors.

FIG. 3a is an upper perspective view of a permit device.

FIG. 3b is an exploded upper perspective view of the permit device.

FIG. 3c is a rear view of the permit device.

FIG. 4 is a block diagram illustrating the permit device and communications within the permit device.

FIG. 5 is an illustration of the overall communications of the present invention without utilizing parking sensors.

FIG. 6 is a flowchart illustrating the overall process for setting up a user account.

FIG. 7 is a flowchart illustrating the overall process of the present invention.

FIG. 8 is a flowchart illustrating the overall process for determining and communicating with a gateway device.

FIG. 9 is a flowchart illustrating the overall process of determining if a vehicle is authorized to park in a parking spot.

FIG. 10 is a flowchart illustrating the overall process of determining if a vehicle leaves the parking spot.

### DETAILED DESCRIPTION OF THE INVENTION

### A. Overview of Invention

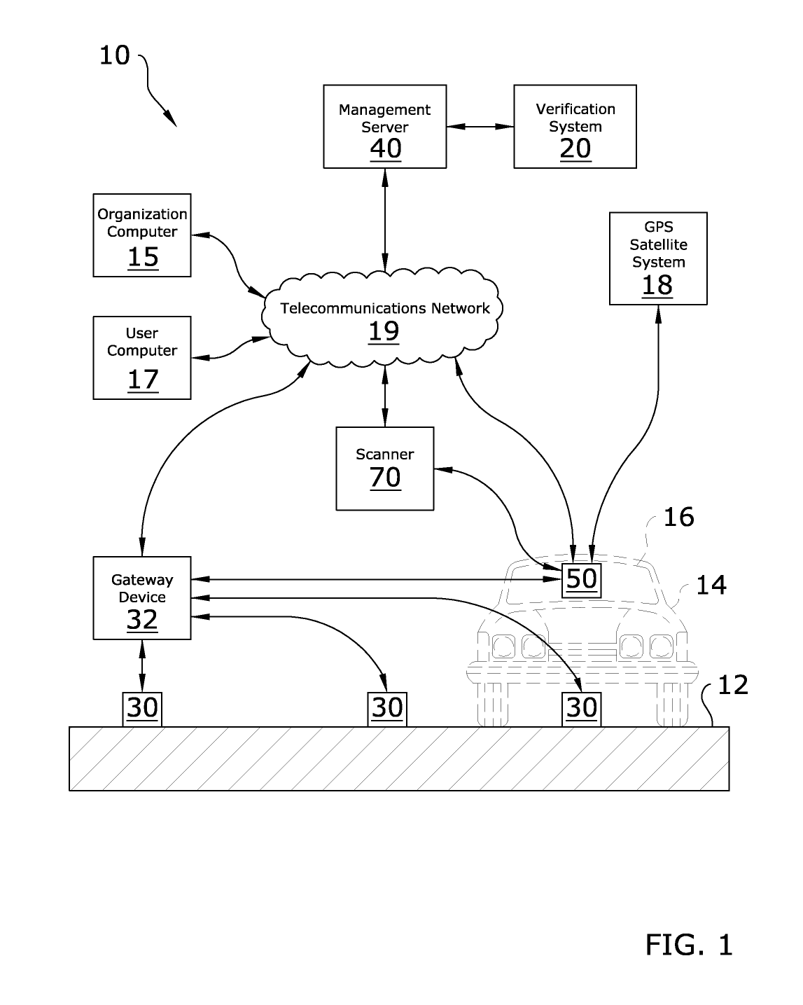

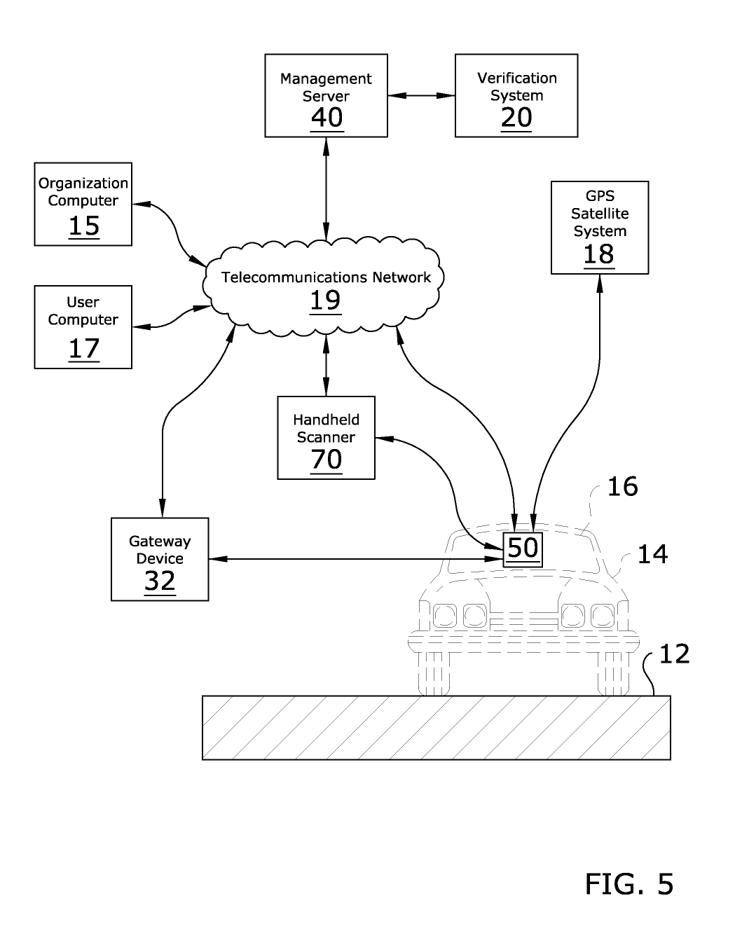

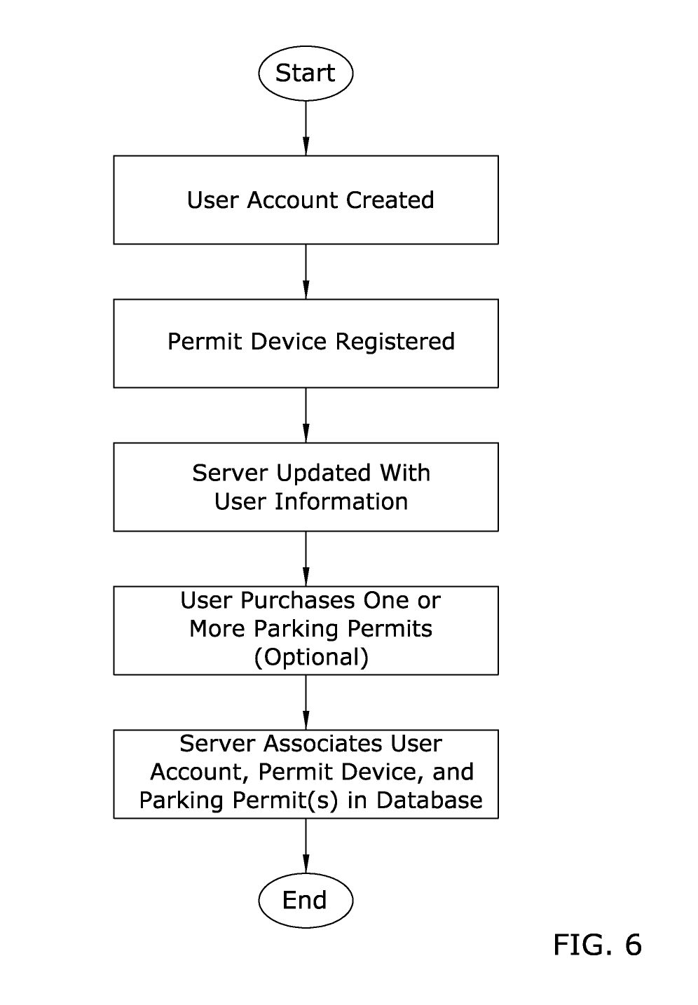

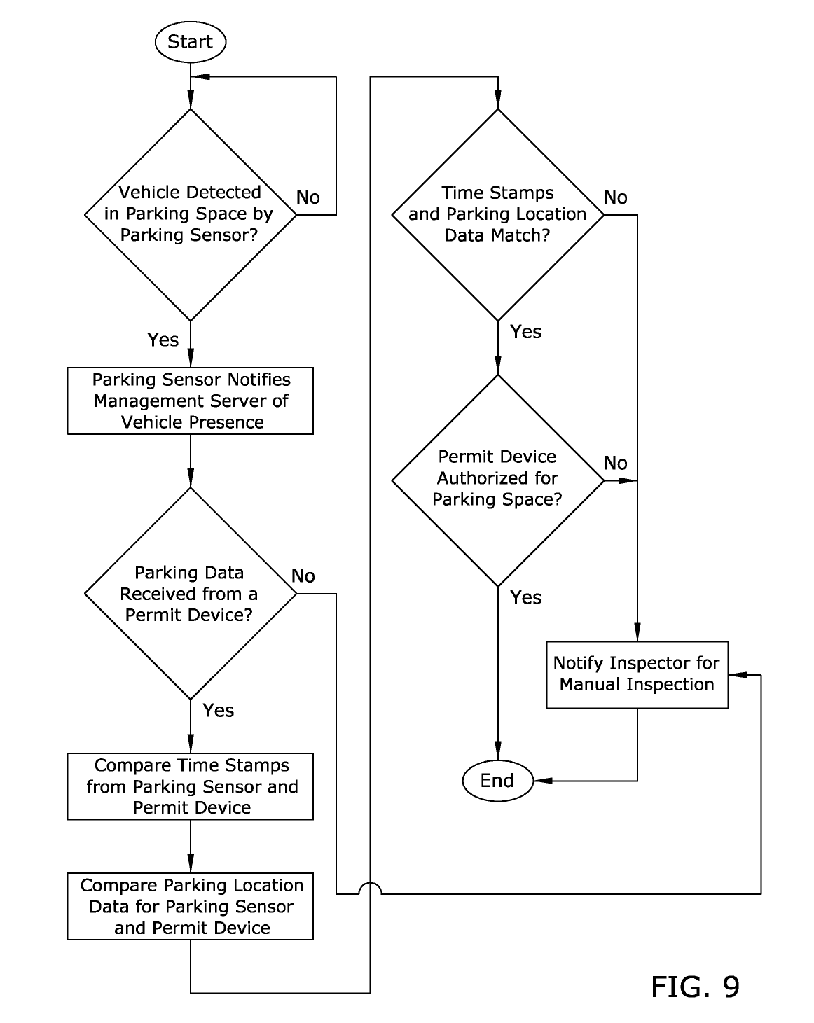

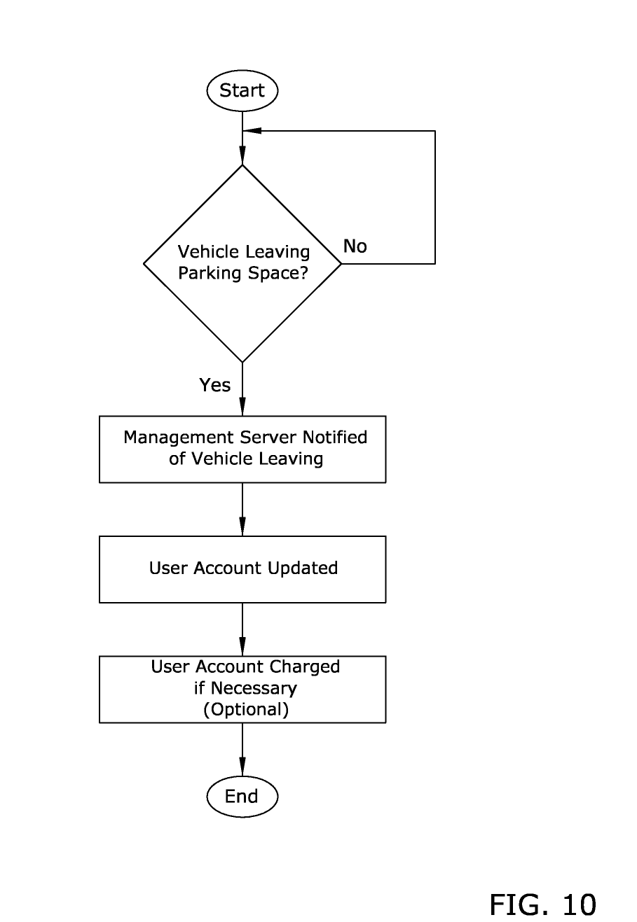

FIGS. 1 through 10 illustrate the present invention. The location-based vehicle parking system generally includes determining the presence of a vehicle 14 within a parking space 11 by a parking sensor 30, communicating sensor data to a management server 40, communicating vehicle data to the management server 40 by a permit device 50 within the vehicle 14, and determining if the vehicle 14 is authorized to park within the parking space 11. A communication is sent to an inspector to manually verify permissions for a vehicle 14 in a parking space 11 if not authorized.

### B. Management Server

The management server 40 may be comprised of any computer, Internet-based computer, cloud based computer, virtual computer, home computer or other computer system capable of receiving and transmitting data via IP networks and the telecommunication networks. The management server 40 may be comprised of any electronic system capable of receiving, storing, calculating and transmitting information (e.g. computer data, etc.).

The management server 40 is utilized in the present invention to receive, store and transmit organization account data and user account data. The management server 40 stores the organization accounts and user accounts in a database. The management server 40 may include a verification system 20 to verify whether a permit device 50 has the parking credentials required to park in a parking spot (alternatively the verification system 20 may be a separate computer).

### C. Organization Accounts

For example, individual organizations (e.g. businesses, government agencies) that manage one or more parking spaces 11 (or a parking lot) can create their own individual organization accounts on the management server 40 through an organization computer 15 connected to the telecommunications network 19 to communicate with the management server 40. A web-based interface is preferably utilized for the organization to create the organization account using basic information and space management information, however, various other types of organization account creation systems may be utilized (e.g. software application).

Information for the organization such as the organization name, organization login credentials, address, contact names, telephone numbers, e-mail address(es), website, payment information (if necessary), financial account information and the like may be included within the organization account data. Additional information about the organization may also be stored within the organization account as needed to operate the invention.

In addition, space management information associated with the organization account of the organization includes information about the parking spaces 11 to be managed such as the name of a parking lot/space, the location for each of the parking spaces 11 being managed (e.g. city, state, country, geographic coordinates), the size (e.g. area, width, length) for each of the parking spaces 11 being managed, any height restrictions for a parking space 11, permissions for each of the parking spaces 11, permits allowed for each of the parking spaces 11, types of parking spaces 11, vehicle 14 types allowed within the parking spaces 11, length of time allowed for a vehicle 14 to park in the parking spot, time restrictions for the parking spaces 11, the total number of parking spaces 11 in a parking lot, the number of parking spaces 11 being managed and the like may be included within the organization account data. The space management information also preferably includes information relating to parking sensors 30 corresponding to each of the parking spaces 11 to help identify which parking space 11 has a vehicle 14 present. The space management information may be associated with an organization account where the organization owns the parking spaces 11 or with a different organization that is managing the parking spaces 11.

### D. User Accounts

The organization managing the parking spaces may create individual user accounts on behalf of the user and/or individual users can create their own individual user accounts on the management server 40 through a user computer 17 (e.g. computer, mobile device, smart phone) connected to the telecommunications network 19 to communicate with the management server 40. A web-based interface is preferably utilized for the user to create the user account, however, an application running on the user computer 17 may also be utilized to setup all of the user's preferences.

Information such as the user's name, user's login credentials, type of vehicle 14, vehicle 14 size (e.g. length, width, height), vehicle 14 license plate, vehicle 14 color, home address, work address, e-mail address(es), website, payment information and the like may be included within the user account data. The user account further includes information about the permit devices 50 associated with the user that the user is allowed to utilize for parking a vehicle 14 and for which vehicles 14 each permit device 50 may be utilized within. The permit device 50 preferably includes a device identifier (e.g. serial number, code) that is electronically transmitted by the permit device 50, wherein the device identifier is associated with the user account to identify both the permit device 50 and the user account.

In addition, the user account preferably includes information regarding parking permits the user can purchase in advance, has previously purchased or have been granted and other parking rights that are associated with the user and/or the permit device 50 collectively referred to as “parking permits”. The user is able to manage, purchase, apply for, cancel and otherwise manipulate the parking permits via the management server 40 as needed. Various types of parking permits for different parking lots and parking spaces 11 may be offered to the user when accessing the user interface for the management server 40 similar to conventional online purchases or applications. Alternatively, the user may apply for or purchase a parking permit directly from an organization and the organization may update the organization account to indicate that the user has a parking permit for the specific parking lot and/or parking spaces 11.

### E. Parking Sensors

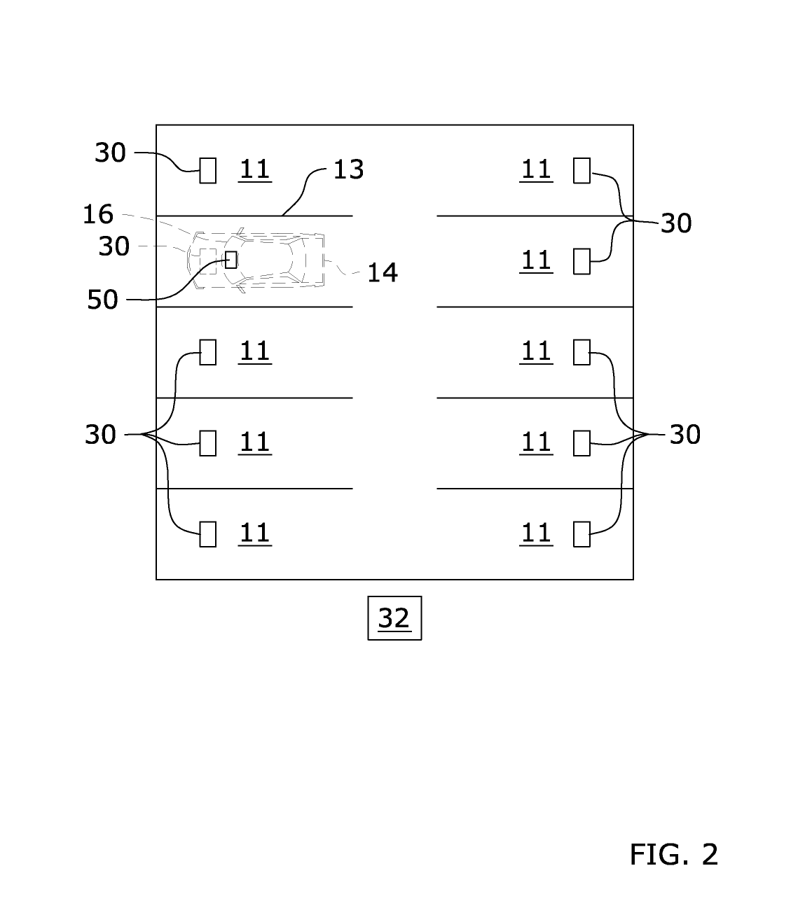

FIG. 2 of the drawings illustrates an example of a parking lot having a plurality of parking spaces 11 each having a generally rectangular shape with parking indicia 13 (e.g. painted lines) defining at least a portion of the boundaries of the parking spaces 11. While parking lots typically are comprised of rows of parking spaces 11, it can be appreciated that the parking lot may have various configurations or a parking lot may be comprised of single parking space 11. Each parking space 11 preferably is assigned a parking identifier (e.g. serial number, code) that is utilized to identify each of the parking spaces 11 in the database of the management server 40, wherein the parking identifier is stored within a sensor database of the management server 40.

Each parking space 11 preferably includes a parking sensor 30 to detect the presence of a vehicle 14 in each respective parking space 11. The parking sensor 30 may be positioned in various locations of an individual parking space 11, however, it is preferable that the parking sensor 30 be positioned approximately 2 meters from the front end of the parking space 11 to be positioned under a parked vehicle 14 as illustrated in FIG. 2 of the drawings. The parking sensor 30 may also detect the presence of the permit device 50 utilizing wireless communications between the parking sensor 30 and the permit device 50 (e.g. the permit device 50 emits a Bluetooth low energy signal that is detected by the parking sensor 30).

The parking sensor 30 is able to detect the presence of a vehicle 14 in the associated parking space 11 for the parking sensor 30 without mistaking a human or pet walking through the parking space 11 as a vehicle 14. Furthermore, the parking sensor 30 preferably does not notify the management server 40 of a vehicle 14 parked in the parking space 11 until after a period of time (e.g. 5 seconds or more) that a vehicle 14 is stationary within the parking space 11 and/or within a specific distance of the parking sensor 30 (e.g. less than 2 feet from the parking sensor 30 when the parking sensor 30 is positioned at the front end of the parking a space as illustrated in FIG. 2 of the drawings. The parking sensor 30 may detect the presence of the vehicle 14 utilizing various types of object presence detection systems such as but not limited to proximity sensors (e.g. RF radiation, light, optical, sound, capacitive, magnetic, inductive proximity sensors), motion sensors (e.g. infrared, ultrasonic, microwave sensors, video), a weight sensor in the parking surface 12 of the parking space 11 and the like.

The parking sensors 30 preferably communicate with the management server 40 via a telecommunications network 19 to indicate that a vehicle 14 is parked in the parking space 11. The parking sensors 30 may access the telecommunications network 19 directly or via a gateway device 32 (e.g. wireless router). The parking sensors 30 may be in communication with the gateway device 32 via a wired connection or wireless connection (e.g. Wi-Fi, Bluetooth and the like). The parking sensors 30 may include a wired connection to an electrical power supply, a battery and/or a solar power system for providing electrical power to the parking sensors 30.

### F. Permit Device

1. Overview.

The permit device 50 may be comprised of any type of electronic device (e.g. computer) for practicing the various aspects of the present invention. For example, the permit device 50 can be a personal computer (e.g. APPLE® based computer, an IBM based computer, or compatible thereof) or tablet computer (e.g. IPAD®). The permit device 50 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The permit device 50 is an electronic device that is adapted for communicating with the management server 40, the scanner 70, the gateway device 32 in the parking lot, parking sensors 30 and/or other devices. The permit device 50 includes memory that may be reprogrammed as needed by the management server 40 or other computer (e.g. changing the device identifier, adding/removing parking permits, changing rules from the parking provider). The permit device 50 further preferably receives signals from a navigation system (e.g. a satellite navigation system such as the Global Positioning System) so the permit device 50 can determine the physical location of the permit device 50 and the vehicle 14 the permit device 50 is associated with.

The permit device 50 is preferably an electronic device that is portable and removable from a vehicle 14 as desired by a user so the permit device 50 may be used in more than one vehicle 14 as desired. However, the permit device 50 may be directly and permanently connected to the vehicle 14 (e.g. part of the electrical system of the vehicle 14). The permit device 50 is preferably positionable in a visible location of the vehicle 14 to allow for manual inspections by a parking inspector, however, the permit device 50 may be located in non-visible locations of the vehicle 14 (e.g. under the hood, beneath the vehicle 14, in the trunk, on the roof of the vehicle 14).

2. Housing.

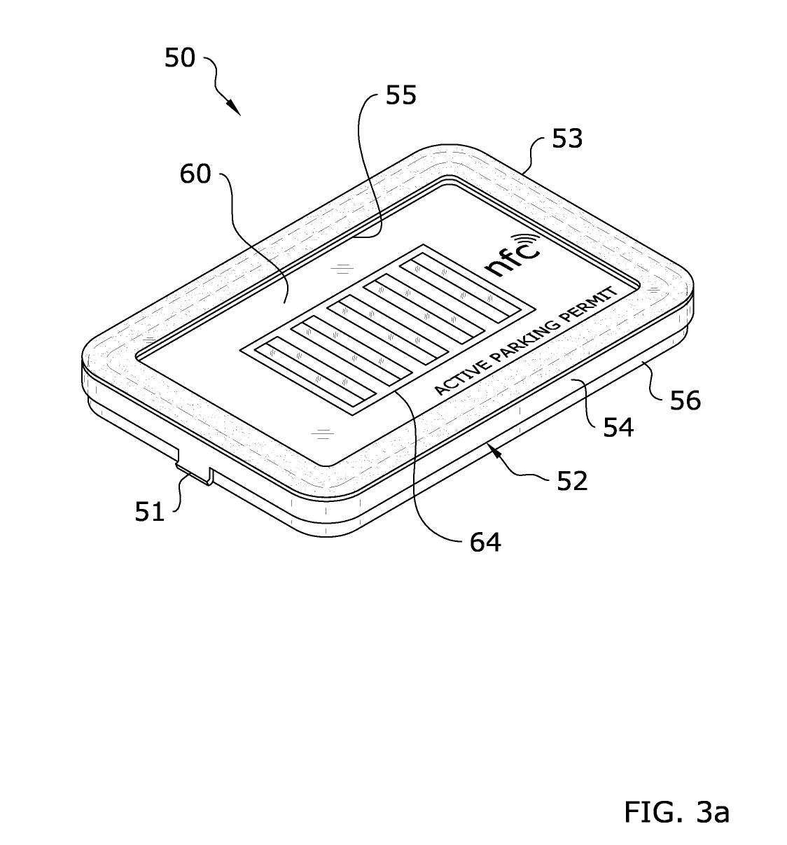

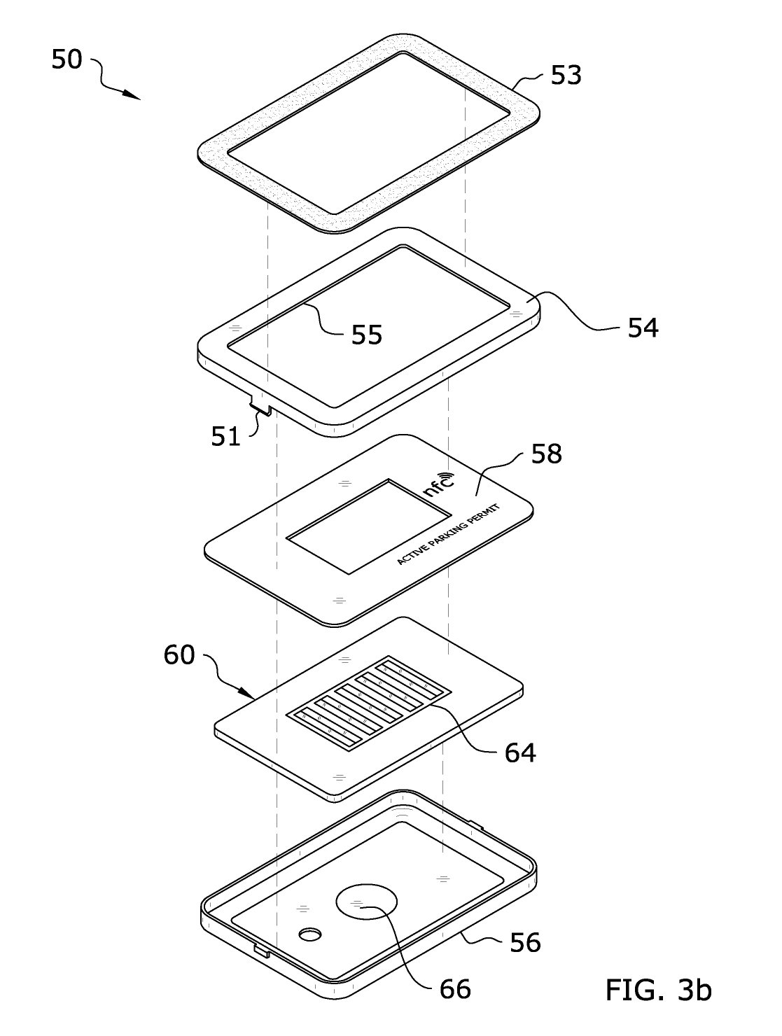

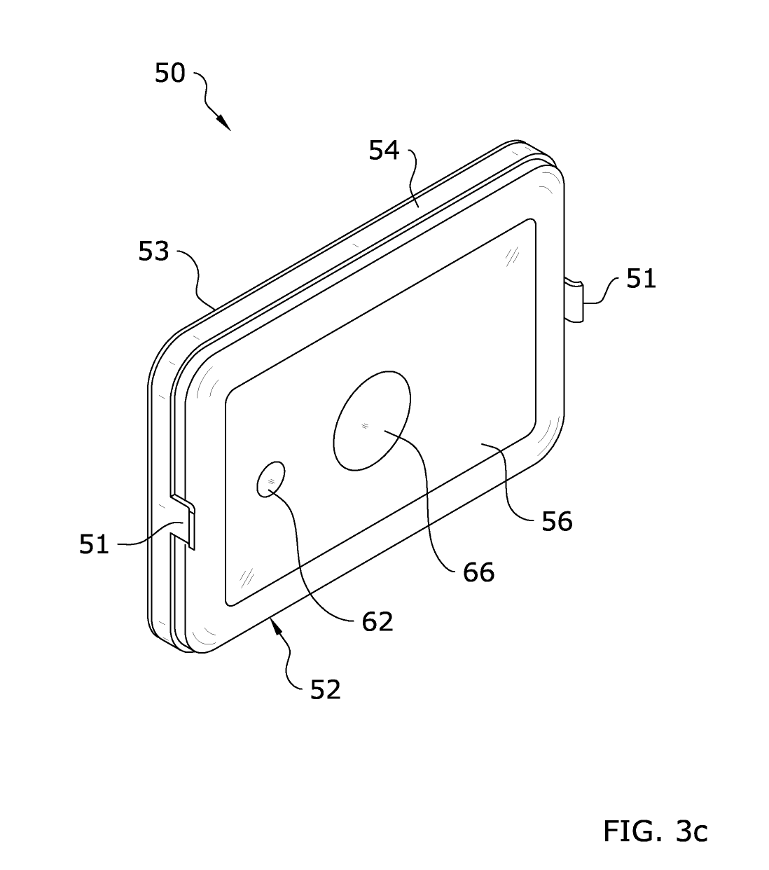

FIGS. 3a through 3c illustrate an exemplary permit device 50 comprised of a housing 52 having a first portion 54 having an opening 55 and second portion 56 that is connectable to the first portion 54 to form a housing 52 having an interior space to store the electrical components of the permit device 50. A plurality of latches 51 or other attachment members extending from the first portion 54 allow for removable connection of the first portion 54 to the second portion 56. By releasing the latches 51, the user is able to remove and/or replace a permit card 60 within the housing 52 as needed. The housing 52 is preferably comprised of a thin and generally rectangular structure as illustrated in FIG. 3a of the drawings. Various other configurations for the housing 52 may be utilized capable of being attached to a window 16 without obstructing the view of the driver.

The housing 52 is preferably attachable to a window 16 (e.g. windshield) of a vehicle 14 utilizing an attachment device 53. FIGS. 3a and 3b illustrate an exemplary attachment device 53 comprised of a length of adhesive tape that surrounds the face of the first portion 54 of the housing 52, wherein the adhesive tape secures to the interior surface of the window 16 of the vehicle 14 thereby exposing through the opening 55 the solar panel 64 and any permit indicia (e.g. a permit number, name of the user, parking lot identifier, parking space 11 identifier and the like) to assist in the visual inspection of the parking permit by an inspector or other parking enforcement personnel.

A faceplate 58 is preferably positioned within the housing 52 with a portion exposed via the opening 55. The faceplate 58 is positioned over the permit card 60 to cover the electronics of the permit card 60 and provide a pleasing visual appearance that may be changed by the user or the business providing the parking permit. The face plate may have various types of indicia such as the name of the parking lot, identification of the parking space 11 (e.g. Lot B, Space #32), indication of the wireless technology used (e.g. NFC for near field communication). The faceplate 58 is a flat structure having an aperture that allows for the solar panel 64 to extend through thereby exposing the solar panel 64 through the opening 55 of the housing 52 as illustrated in FIGS. 3a and 3b of the drawings.

3. Permit Card.

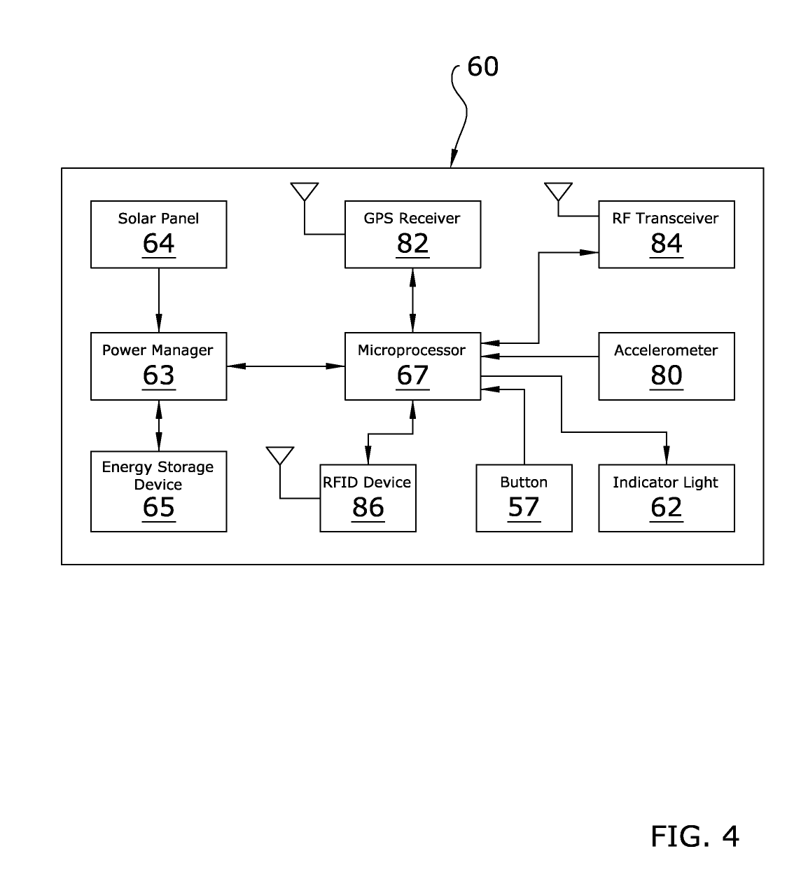

The permit device 50 preferably includes a permit card 60, wherein an exemplary permit card 60 is illustrated in FIGS. 3a, 3b and 4 of the drawings. The permit card 60 preferably includes all or a significant portion of the electronics used for the permit device 50. The permit card 60 may be removed and/or replaced by the user or the business as needed. The permit card 60 is portable to allow for placement in different housings 52 mounted in different vehicles 14 that the user operates.

The permit card 60 may be comprised of a printed circuit board (PCB) or other electronic device. As shown in FIG. 4, the permit card 60 includes a microprocessor 67 that receives, calculates, stores and transmits data. The microprocessor 67 includes memory that stores the device identifier, a user identifier and other parking related information. The information stored within the permit card 60 may be transmitted to the management server 40, the scanner 70, the gateway device 32, a organization computer 15 and/or a user computer 17.

4. RFID.

The permit card 60 further preferably includes RFID capability that allows for the scanner 70 to identify the device identifier and user information by scanning the permit device 50. The RFID device 86 within the permit card 60 may be active or passive. Furthermore, the RFID device 86 (including the memory within the RFID device 86) is preferably in bidirectional communication with the microprocessor 67 so that the RFID memory may be reprogrammed by the microprocessor 67 as needed to update a device identifier, user information or other related data.

5. Energy Storage Device.

The permit card 60 further preferably includes an energy storage device 65 (e.g. battery) that is electrically connected to the microprocessor 67 and other components of the permit card 60 to provide electrical power. The energy storage device 65 may be removable and/or rechargeable. The energy storage device 65 is preferably electrically recharged by a solar panel 64 with a power manager 63 as further shown in FIG. 4 of the drawings. Recharging by the solar panel 64 prevents the user from having to periodically replace the energy storage device 65 and extends the useful life thereof. The power manager 63 controls the charging of the energy storage device 65 to ensure proper charging.

6. Navigation System.

The permit card 60 further preferably includes a GPS receiver 82 that receives signals from a GPS satellite system 18. The GPS receiver 82 is in communication with the microprocessor 67 to provide location and/or time information to the microprocessor 67 to assist in identifying the location of the permit device 50. Various types of other navigation technologies such as land-based location towers may be used to identify the location of the permit device 50 and vehicle 14 of the user.

7. RF Transceiver.

The permit card 60 also includes an RF transceiver 84 that communicates wirelessly with the gateway device 32 and/or the telecommunications network 19 acting as a communications gateway between the permit device 50 and the management server 40. The RF transceiver 84 may communication via various wireless technologies such as but not limited to Wi-Fi, Bluetooth and the like.

8. Indicator Light and Buttons.

The permit card 60 preferably includes an indicator light 62 to indicate the status of the permit device 50 (e.g. green light indicates “On”, red light indicates “Off”, blinking green light indicates the permit device 50 is communicating with the management server 40, blinking red light indicates the permit device 50 has detected the vehicle 14 is parked and is checking for a connecting with a local gateway device 32). The permit card 60 further preferably includes at least one button 66 to allow for the user to manually power the permit device 50 on or off along with other basic functions. The permit card 60 may also include a display screen electrically connected to the microprocessor 67 to display various types of information to the user utilizing the permit device 50. The indicator light 62 and the button 66 are both electrically connected to the microprocessor 67 as illustrated in FIG. 4.

9. Accelerometer.

The permit card 60 and therefore the permit device 50 further preferably includes an accelerometer 80 which is in communication with the microprocessor 67. The accelerometer 80 is utilized as a low-power system to determine when a vehicle 14 has parked and therefore the permit device 50 should leave a “sleep mode” which requires a small amount of electrical power and enter an “active mode” which requires additional electrical power.

The accelerometer 80 detects movement of the permit device 50 (which in turn is detecting movement of the vehicle 14 the permit device 50 is positioned within) and when there is movement present the permit device 50 determines that the vehicle 14 is moving and therefore not parked. When the accelerometer 80 does not detect movement, the permit device 50 determines that the vehicle 14 is not moving and therefore is parked.

To prevent the permit device 50 from unnecessarily being activated to active mode constantly, there is preferably a minimum delay period of time (e.g. 20 seconds or more) where the accelerometer 80 does not detect movement before activating the permit device 50 from sleep mode to active mode. The amount of minimum delay period of time may be adjusted by the user, organization or other third-party by programming the microprocessor 67.

When the vehicle 14 is determined by the microprocessor 67 and/or the accelerometer 80 to be moving (i.e. not parked), non-essential electronic devices are deactivated to conserve electrical energy within the energy storage device 65. For example, when the vehicle 14 is parked, the GPS receiver 82, the RF transceiver 84 and the RFID device 86 are preferably deactivated to prevent unnecessary power consumption. However, when the vehicle 14 is determined by the microprocessor 67 and/or the accelerometer 80 to be parked, then the GPS receiver 82, the RF transceiver 84 and the RFID are activated.

Alternatives to the accelerometer 80 may be utilized such as communication between the permit device 50 and the speed sensors of the vehicle 14, the GPS receiver 82 and the like. However, all of these technologies require additional electrical power consumption and are not preferred since they require either a larger energy storage device 65, direct electrical powering of the permit device 50 and/or increased replacement of the energy storage device 65. For example, the GPS receiver 82 may be activated to detect whether the vehicle 14 is moving or not similar to the accelerometer 80 (including using the minimum delay period of time).

### G. Scanner

The scanner 70 is preferably a handheld and portable device that is used by an inspector or other personnel managing the parking lot to manually inspect a vehicle 14 parked in a parking space 11 that has not been automatically verified by the management server 40. Independent verification of the vehicle 14 prior to parking enforcement actions being taken is important to prevent an authorized vehicle 14 from receiving a wrongful parking enforcement action (e.g. ticket, towing) simply because the permit device 50 was not able to communicate with the management server 40 or other issue.

The scanner 70 may be comprised of any electronic device capable of wirelessly communicating with the permit device 50 to acquire the identification of the permit device 50. Various wireless technologies may be utilized for the scanner 70 to communicate with the permit device 50 such as but not limited to near field communications (NFC), Bluetooth and the like.

Once the identification of the permit device 50 is acquired, the identification data and any other data acquired from the permit device 50 is then communicated to the management server 40 via the telecommunications network 19 from the scanner 70 for verification by the management server 40. Alternatively, the scanner 70 may communicate the data acquired to the management server 40 “offline” periodically. If the management server 40 verifies that the permit device 50 is authorized for the parking space 11, the management server 40 communicates to the scanner 70 which is then displayed on a display screen of the scanner 70 that the vehicle 14 is authorized to park within the parking space 11 (if not authorized, the scanner 70 will display to the inspector that the vehicle 14 is not authorized). Alternatively the management server 40 may only indicate which parking space 11 the vehicle 14 with the permit device 50 is allowed to park within and the inspector then independently determines if the vehicle 14 is authorized to park within the parking space 11. If the vehicle 14 is not authorized to park within the parking space 11, the inspector then may take appropriate action such as ticketing the vehicle 14, towing the vehicle 14, securing wheel clamps and the like.

### H. Telecommunications Network

The present invention may be utilized upon any telecommunications network 19 capable of transmitting data including voice data and other types of electronic data. Examples of suitable telecommunications networks 19 for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single telecommunications network 19 or multiple telecommunications networks 19 concurrently. Various protocols may be utilized by the electronic devices for communications such as but not limited to HTTP, SMTP, FTP and WAP (Wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary telecommunications network 19 for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### I. Operation of Invention

1. Initial System Setup.

In use, a plurality of parking sensors 30 are positioned with respect to each of the parking spaces 11 to be managed as illustrated in FIGS. 1 and 2 of the drawings. In an alternative embodiment, the present invention does not utilize parking sensors 30 to detect the presence of a vehicle 14 within the parking space 11 and instead relies upon the permit device 50 to communicate with the management server 40 to verify the parking credentials for the permit device 50 and corresponding user.

The user acquires the permit device 50 and acquires the necessary parking permit(s) which are required by the user to park within the desired parking spaces 11. The user then positions the permit device 50 in the window 16 of the vehicle 14 and preferably attaches the permit device 50 to the interior of the windshield of the vehicle 14 as illustrated in FIG. 1 of the drawings. The user drives the vehicle 14 as they normally would wherein the accelerometer 80 detects movement of the vehicle 14 and therefore determines that the vehicle 14 is not parked.

2. Detection of Vehicle by Parking Sensor.

Once the user identifies a parking space 11 to park in, the user drives the vehicle 14 into the parking space 11 and stops the vehicle 14 as shown in FIG. 2 of the drawings. The parking sensor 30 associated with the parking space 11 detects the parking of the vehicle 14 in the corresponding parking space 11 and after such detection notifies the management server 40 that a vehicle 14 is parked within the parking space 11 thereby activating a verification system 20 for the management server 40 to determine if the vehicle 14 is identifiable and has the required parking credentials to park within the parking space 11. In particular, after detection of the vehicle 14, the parking sensor 30 transmits sensor data which includes a sensor identifier (e.g. Sensor #123456789) to identify the parking sensor 30, a sensor time stamp indicating the time (e.g. 12:43 pm) the vehicle 14 was parked in the parking space 11 and/or date (e.g. Nov. 1, 2013) the vehicle 14 was parked in the parking space 11.

The sensor data may also include additional data such as an image of the vehicle 14 recorded by a camera within the parking sensor 30, weather conditions (e.g. temperature), ambient light conditions and related information. Once the management server 40 is notified via the sensor data that a vehicle 14 is in a managed parking space 11, the management server 40 attempts to determine if the vehicle 14 is allowed to park in the parking space 11 or not.

3. Detection of Parking of Vehicle by Permit Device.

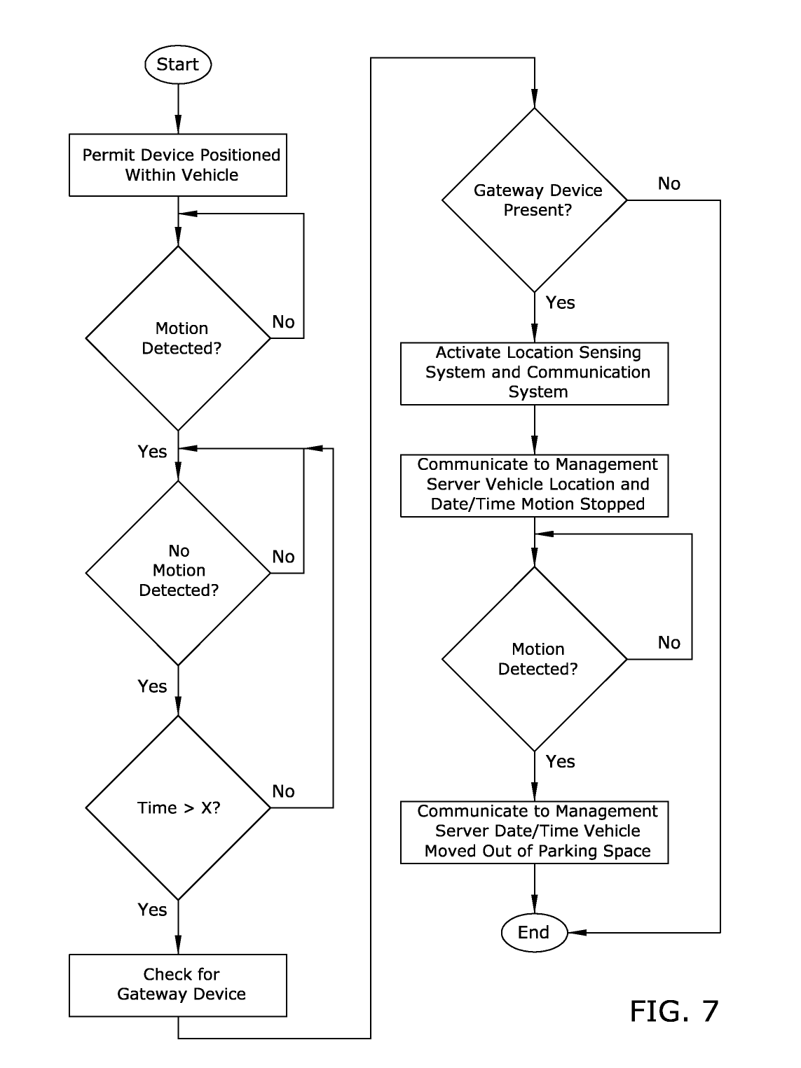

Concurrently with the detection of the vehicle 14 by the parking sensor 30, the permit device 50 determines that the vehicle 14 is parked because of the lack of motion of the vehicle 14 (i.e. determines the motion state of the permit device 50 using the accelerometer 80 and/or the GPS receiver 82). As illustrated in FIG. 7, after no motion is detected for a period of time greater than X (e.g. 20 seconds), the microprocessor 67 determines if a gateway device 32 is present to communicate the vehicle data to such as via the RF transceiver 84. Once the vehicle 14 is determined to be parked by the permit device 50, a permit time stamp is saved recording the time and date for when the vehicle 14 was determined to be parked.

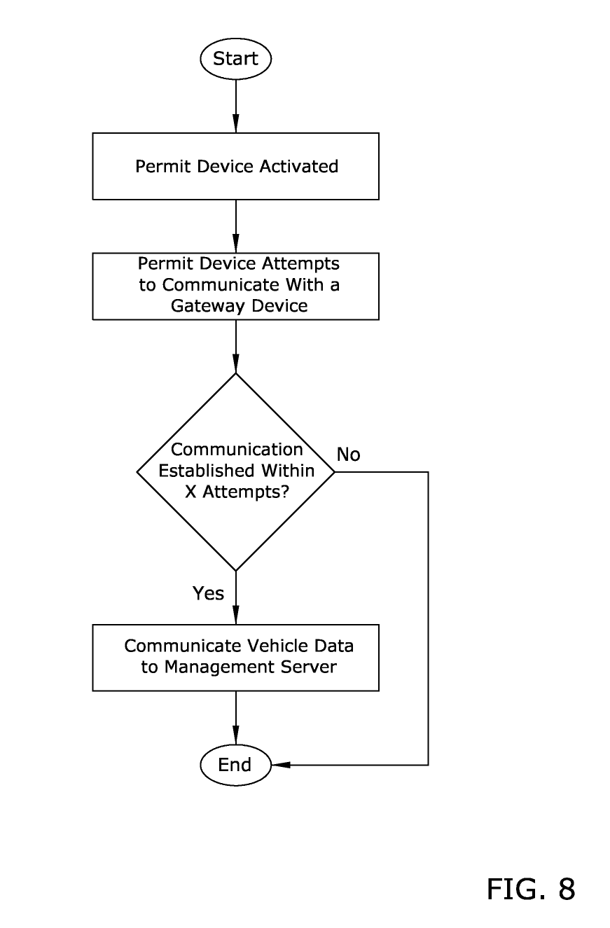

If the microprocessor 67 determines that a gateway device 32 is not present, then the permit device 50 remains in sleep mode to conserve electrical power. Alternatively, if the permit device 50 is activated and attempts to communicate with a local gateway device 32 associated with the parking lot and fails to communicate with a gateway device 32 within X attempts (e.g. 9 attempts) then the permit device 50 is deactivated to sleep mode as shown in FIG. 8 of the drawings.

If a gateway device 32 is present and/or if the permit device 50 includes an RF transceiver 84 that is capable of directly communicating with the telecommunications network 19 (e.g. a transceiver capable of communicating with a cellular telephone system), then the permit device 50 is activated to active mode thereby activating the location sensing system to determine the location of the vehicle 14 and the communication system to allow for communication with the management server 40. In particular, the GPS receiver 82 within the permit device 50 is activated to determine the location of the vehicle 14 and the current time. The vehicle data is communicated from the permit device 50 to the management server 40 by the RF transceiver 84. The vehicle data transmitted to the management server 40 includes the permit time stamp (e.g. 12:44 pm), the permit identifier (e.g. Permit #987654321) and the location of the vehicle 14. Once the vehicle data has been properly transmitted, the permit device 50 preferably goes back into a lower energy consumption sleep mode until the vehicle 14 is moving again.

4. Verifying Vehicle's Parking Credentials.

If the management server 40 receives the vehicle data within a required amount of time, the management server 40 then compares the vehicle data provided by the permit device 50 with the sensor data provided by the parking sensor 30 to verify if the vehicle 14 is authorized to park within the parking space 11. In particular, the management server 40 utilizes the sensor data to identify the parking space 11 (including location of the parking space 11) and then compares the vehicle data (including the location of the vehicle 14) to determine if the vehicle 14 is parked in (or near) the parking space 11. If an exact match is not found solely by location, the management server 40 may also compare vehicle data that is near (e.g. within 30 feet) of the parking space 11 and compare the sensor time stamp with the permit time stamp to determine if they are close enough (e.g. within 5 minutes of one another) to be a match.

If an exact match is found for a permit device 50 and the parking space 11 (or a permit device 50 is determined to be close enough physically and the time stamps are close enough), then the management server 40 assumes that the permit device 50 is the device that is within the vehicle 14 that parked within the parking space 11. The management server 40 then determines if the permit device 50 (and the corresponding user) has the proper parking credentials to park within the parking space 11. If the management server 40 determines that the user is allowed to park within the parking space 11, the management server 40 then updates its records accordingly and waits for the vehicle 14 to be detected exiting the parking space 11.

If the permit device 50 is not verified to be allowed in the parking space 11 or if no permit device 50 is determined to be associated with the parking space 11, the management server 40 notifies an inspector via a message (e.g. automated telephone call, e-mail, text message) that a potentially unauthorized vehicle 14 is parked in the parking space 11. The management server 40 further notifies the inspector of the location of the parking space 11 and the time the vehicle 14 parked within the parking space 11. The inspector then manually inspects the vehicle 14 and the corresponding permit device 50 to determine what action, if any, is required as discussed below.

5. Detection of Vehicle Exiting the Parking Space.

When the vehicle 14 is moved from the parking space 11, the accelerometer 80 detects the movement and switches the permit device 50 from the sleep mode to the active mode. The permit device 50 communicates through the gateway device 32 that the vehicle 14 is moving and is leaving the parking space 11 at the exit date and exit time (along with the device identifier). The management server 40 records the same within the database and the user may be billed accordingly if a charge applies for the time for parking in the parking space 11. In addition, the parking sensor 30 detects the vehicle 14 exiting the parking space 11 and also notifies the management server 40 to act as a secondary verification system 20 by submitting the exit time and exit date detected (along with the sensor identifier) so the management server 40 may verify that the vehicle 14 has left the parking space 11. If only the permit device 50 detects that the vehicle 14 has left but not the parking sensor 30, a manual inspection may be requested to determine if the vehicle 14 has left or not to avoid fraud issues.

6. Manual Inspection.

If the management server 40 does not receive vehicle data from a vehicle 14 located within the parking space 11 associated with the parking sensor 30 that sent the sensor data to the management server 40 that a vehicle 14 had parked in the parking space 11 within a period of time (e.g. 9 minutes), the management server 40 then notifies an inspector or other personnel that a vehicle 14 is parked in the corresponding parking space 11 without being verified by the management server 40 and a manual inspection is required. The inspector or other personnel travels to the parking space 11 and performs a visual inspection to see if the permit device 50 indicates that the vehicle 14 is allowed in the parking space 11. The inspector further uses the scanner 70 to acquire the device identifier and user information from the permit device 50 which is then communicated to the management server 40 (or alternative viewed by the inspector for manual verification). The inspector takes the necessary actions if the vehicle 14 is not authorized for the parking space 11 (e.g. ticketing, towing, wheel clamp). If the vehicle 14 is authorized, the inspector notifies the management server 40 that the vehicle 14 is authorized along with identifying the permit device 50.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method for managing a parking space for a vehicle, comprising:
determining if a vehicle is parked in a parking space, wherein said vehicle includes a permit device;
communicating vehicle data to a management server by said permit device; and
verifying if said vehicle is authorized to park within said parking space.

2. The method of claim 1, including the step of notifying an inspector if said step of verifying is unable to determine if said vehicle is authorized or determines that said vehicle is not authorized.

3. The method of claim 2, including the step of manually verifying by said inspector if said vehicle is authorized to park within said parking space.

4. The method of claim 3, wherein said step of manually verifying is comprised of said inspector using a scanner to communicate with said permit device.

5. The method of claim 4, wherein said scanner is comprised of a handheld device that communicates wirelessly with said permit device.

6. The method of claim 3, wherein said step of manually verifying is comprised of said inspector visually inspecting said permit device, wherein said permit device is in a visible location of said vehicle.

7. The method of claim 6, wherein said permit device is attached to a window of said vehicle.

8. The method of claim 1, wherein said parking device is removable from said vehicle.

9. The method of claim 1, wherein said step of determining if a vehicle is parked in a parking space is comprised of determining a motion state of said permit device.

10. The method of claim 9, wherein said motion state is determined by an accelerometer.

11. The method of claim 9, wherein when said motion state is inactive for at least a minimum period of time, said motion state is determined to be inactive.

12. The method of claim 9, wherein when said motion state is determined to be active, said permit device is switched to sleep mode.

13. The method of claim 12, wherein when said motion state is determined to be inactive, said permit device is switched from sleep mode to active mode to communicate with said management server.

14. The method of claim 13, wherein said permit device identifies a location for said vehicle and communicates said location to said management server when in active mode.

15. The method of claim 1, including the step of identifying a location for said vehicle and communicating said location to said management server by said permit device when in active mode.

16. The method of claim 15, wherein said step of determining if a vehicle is parked in a parking space is comprised of detecting a presence of said vehicle by a parking sensor associated with said parking space, wherein said parking sensor communicates detection of said presence of said vehicle to said management server.

17. The method of claim 1, wherein said permit device is comprised of a housing and a permit card removably positioned within said housing, wherein said permit card includes a microprocessor, a GPS receiver in communication with said microprocessor, a transceiver in communication with said microprocessor, and a solar panel in electrical communication with an energy storage device, wherein said energy storage device is electrically connected to said microprocessor.

18. A method for managing a parking space for a vehicle, comprising:
detecting if a vehicle is parked in a parking space by a parking sensor associated with said parking space, wherein said vehicle includes a permit device;
communicating sensor data to a management server by said parking sensor after detecting said vehicle in said parking space, wherein said sensor data includes a sensor time stamp and a sensor identifier;
communicating vehicle data to said management server by said permit device, wherein said vehicle data includes a permit time stamp and a permit identifier; and
verifying if said vehicle is authorized to park within said parking space.

19. The method of claim 18, wherein said step of verifying is comprised of comparing said sensor time stamp to said permit time stamp.

20. The method of claim 18, wherein said step of verifying is comprised of identifying said parking space using said sensor identifier and comparing a location of said parking space to a location of said permit device.
